(19) United States
(12) Patent Application Publication
(10) Pub. No.: US 2019/0080385 A1
(43) Pub. Date: Mar. 14, 2019

(54) SYSTEM AND METHOD FOR PROVIDING A USER WITH RECOMMENDATIONS INDICATING A FITNESS LEVEL OF ONE OF MORE TOPICAL SKIN PRODUCTS WITH A PERSONAL CARE DEVICE

(71) Applicant: KONINKLIJKE PHILIPS N.V., EINDHOVEN (NL)

(72) Inventors: MARGARET RUTH HORTON, EINDHOVEN (NL); JONATHAN ALAMBRA PALERO, EINDHOVEN (NL); SEVERIN LUC RAMSES HARVEY, EINDHOVEN (NL)

(21) Appl. No.: 16/063,488

(22) PCT Filed: Dec. 19, 2016
(86) PCT No.: PCT/IB2016/057760

§ 371 Date: Jun. 18, 2018

Related U.S. Application Data
(60) Provisional application No. 62/271,383, filed on Dec. 28, 2015.

(51) Int. Cl. G06Q 30/06; G06Q 30/02

(52) U.S. Cl. CPC G06Q 30/0631; G06Q 30/0203; G06Q 30/0282

(57) ABSTRACT

The present disclosure pertains to a system configured to provide a user with recommendations indicating a fitness level of one or more topical skin products with a personal care device. The system comprises one or more hardware processors configured by machine-readable instructions to: obtain information that identifies the personal care device; access, via a network, one or more databases storing one or more reviews associated with the personal care device, wherein the reviews include information about user experience with the personal care device and the one or more topical skin products; extract, from the reviews associated with the personal care device, information indicating the fitness level of the one or more topical skin products with the personal care device; and generate one or more recommendations indicating the fitness level of the one or more topical skin products with the personal care device based on analysis of the extracted reviews.

### FIELD OF THE INVENTION

The present disclosure pertains to a system and method for providing a user with recommendations indicating a fitness level of one or more topical skin products with a personal care device.

### BACKGROUND OF THE INVENTION

Personal care device and topical skin products are known. Users of personal care devices today use topical skin products available from a wide variety of brands in combination with their devices as part of their skin care ritual. For example, the topical skin products may be used with the device (e.g., shaving foam used together with a shaving device) or applied as a post-device treatment. Unexpected and undesired skin reactions can occur after application of some topical skin products during or after use of such devices. Such reactions may include redness, erythema, edema, itching sensation, burning sensation or even allergy and sensitization. For example, in some cases, reactions may be exacerbated by the exfoliating effect of cosmetic devices, whereby the skin barrier is temporarily disrupted or removed by such treatments.

### SUMMARY OF THE INVENTION

Accordingly, one or more aspects of the present disclosure relate to a system configured to provide a user with recommendations indicating a fitness level of one or more topical skin products with a personal care device. The system comprises one or more hardware processors configured by machine-readable instructions to: obtain information that identifies the personal care device; access, via a network, one or more databases storing one or more reviews associated with the personal care device, wherein the reviews include information about user experience with the personal care device and the one or more topical skin products; extract, from the reviews associated with the personal care device, information indicating the fitness level of the one or more topical skin products with the personal care device; and generate one or more recommendations indicating the fitness level of the one or more topical skin products with the personal care device based on analysis of the extracted reviews.

Another aspect of the present disclosure relates to a method for providing a user with recommendations indicating a fitness level of one or more topical skin products with a personal care device with a recommendation system. The system comprises one or more hardware processors and/or other components. The method comprises: obtaining, with the one or more hardware processors, information that identifies the personal care device; accessing, with the one or more hardware processors, via a network, one or more databases storing one or more reviews associated with the personal care device, wherein the reviews include information about user experience with the personal care device and the one or more topical skin products; extracting, with the one or more hardware processors, from the reviews associated with the personal care device, information indicating the fitness level of the one or more topical skin products with the personal care device; and generating, with the one or more hardware processors, one or more recommendations indicating the fitness level of the one or more topical skin products with the personal care device based on analysis of the extracted reviews.

Still another aspect of present disclosure relates to a system configured to provide a user with recommendations indicating a fitness level of one or more topical skin products with a personal care device. The system comprises means for obtaining information that identifies the personal care device; means for accessing, via a network, one or more databases storing one or more reviews associated with the personal care device, wherein the reviews include information about user experience with the personal care device and the one or more topical skin products; means for extracting from the reviews associated with the personal care device, information indicating the fitness level of the one or more topical skin products with the personal care device; and means for generating one or more recommendations indicating the fitness level of the one or more topical skin products with the personal care device based on analysis of the extracted reviews.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a schematic illustration of a system for providing a user with recommendations indicating a fitness level of one or more topical skin products with a personal care device in accordance with one or more implementations.

FIG. 2 illustrates an example diagram of operations of system 10 in accordance with one or more implementations.

FIG. 3 illustrates an example diagram of operations of system 10 in accordance with one or more implementations.

FIG. 4 illustrates a method for providing a user with recommendations indicating a fitness level of one or more topical skin products with a personal care device in accordance with one or more implementations.

### DETAILED DESCRIPTION OF THE EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Along with instructions for use, personal care devices provide general written warnings to the user to discontinue use of the device, the topical skin product or both if unexpected skin reactions occur. Users are usually left to experiment themselves with device and topical combinations and seek advice from the user community. Cosmetic professionals in beauty/cosmetic stores may offer some advice to the user, but often the advice is either biased (professionals push for their own brands or sales targets), or limited to their personal experience or the experience of the customers of the store. Providing specific product-device compatibility advice given the magnitude of cosmetic products offerings available on the market is not feasible by a cosmetic professional, as millions of device-formula combinations are possible in such open systems. For example, advising consumers to only use formulas containing a particular active ingredient does not ensure that the concentration of the active ingredient is sufficient for a desirable effect, that the formulation enables sufficient penetration of the active ingredient to the skin, nor that other ingredients in the formula may cause undesirable effects despite the inclusion of a desirable recommended active ingredient.

To overcome this problem, some manufacturers offer so-called “bi-pack” kits, where a cosmetic device is sold as part of a kit including topical formulas intended specifically to be used with such devices. But offering such kits requires that the personal care device be marketed and distributed with a cosmetic product, and/or requires partnering with a brand or supplier. It also requires manufacturer testing for compatibility of the formula and device for claim support and safety. It may also limit the options of the consumer for choosing his/her own preferred brand or product.

The present system is configured to provide meaningful information regarding the compatibility of topical skin products and personal care device combinations. The present system is configured to access the knowledge available from the online user review community and conveniently provide it to consumers seeking input on the compatibility of topical skin formula and device combinations, in particular for their skin needs and conditions.

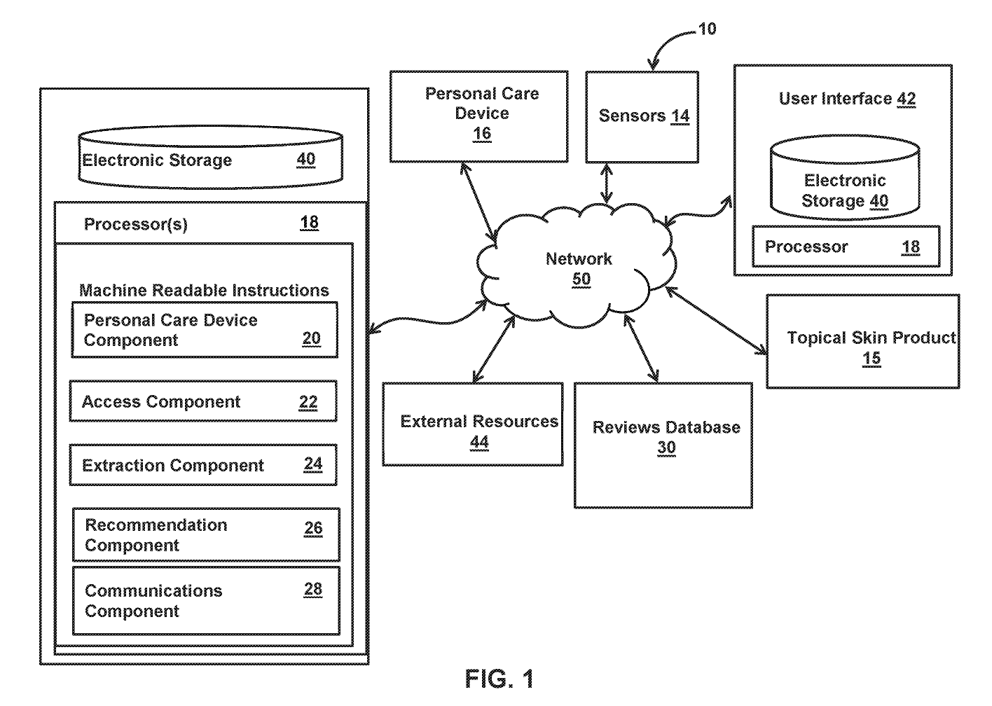

FIG. 1 is a schematic illustration of a system 10 configured to provide a user with recommendations indicating a fitness level of one or more topical skin products 15 with a personal care device 16. Users of personal care devices are usually free to use whatever additional topical skin products or formulas they desire with some generic advice related to safety. Cosmetic professionals may offer advice based on their own knowledge, experience, and sometimes they only refer products from the brands they represent. The user might need to meet personally with the professional for a consultation, where the user answers questions about his goals, his skin type, and/or his hygiene routine, for example. Such a consultation make include skin measurement or objective assessment by a professional or device prior to recommending a topical skin product to go with the personal care devices. Given the millions of possible combinations it's virtually impossible for a cosmetic professional to give a recommendation that takes into consideration multiple factors (e.g., feedback from other users of the personal care device and topical skin products available on the market). The present system addresses the above shortcomings by providing a system for electronically generating recommendations for the users that will take into consideration multiple factors, and will potentially offer the user a better understanding of his/her options when it comes to choosing a topical skin product for his/he personal care device. For example, some desirable and/or potentially synergistic effects due to the combination of a topical skin product with a device may be possible. For example, a device that stimulates renewal of the skin epidermis may compliment a topical skin product containing an active ingredient that stimulates reduction of skin pigmentation production so that the total quantity of pigment in the epidermis is reduced for a desired skin fairness boosting effect. Another example would be the use of a topical skin product during the shaving process that reduces the friction of the shaving head with the skin due to a lubricating effect of the formula for an overall effect of less skin irritation. The reduction of the skin barrier may lead to improved percutaneous penetration of active ingredients, which can also lead to a desirable effect of enhanced efficacy of a cosmetic formula, or less application requirement of a topical skin product.

In some embodiments, system 10 comprises a personal care device 16, one or more topical skin products 15, hardware processor(s) 18, reviews database(s) 30, electronic storage 40, a user interface 42, external resources 44, and/or other components. One or more components of system 10 may be communicatively coupled via a network 50.

Personal care device 16 is a skin treatment device for personal care. Personal care device 16 may be used to cleanse, massage, exfoliate, heat or cool, treat skin conditions (e.g., acne, blemishes, dark spots, wrinkles, etc.), remove hair, resurface skin, and/or apply one or more skin products. Personal care devices include skin treatment devices based on mechanical and energy delivery to the skin. Personal care device 16 may be acquired at cosmetic stores, pharmacies, department store, online stores, and/or specialty stores. In some embodiments, personal care device may be acquired at a dermatologist's office. Generally, a user may use/operate personal care device 16 easily without requiring a professional assistance. For example, personal care device 16 may be and/or include shaving devices, toothbrushes, tongue cleansers, microdermabrasion devices, skin cleansing devices, exfoliating devices, skin firming devices, skin rejuvenation devices, skin massage devices, skin steaming devices, skin cooling devices, and/or other devices.

Topical skin products 15, as used herein, refer to topical products that are applied to a particular place on or in the body for personal hygiene, and/or beautification. Topical skin products (15) include topical products that are applied to a body surface such as the skin or mucous membranes. In some embodiments, topical skin products (15) may include pharmaceutical formulations for treating skin conditions or health conditions. Examples of topical skin products include creams, foams, gels, lotions, serums, tonics, pastes, ointments, cleansing pads, toothpaste, exfoliating formulas, masks, and/or other topical products. In some embodiments, topical skin products include topical products applied to a surface of a tooth, and/or gum. Topical skin products 15 may be used concurrently with the personal care device 16 or without the personal care device 16. In some embodiments, the topical skin products 15 may have a different formulas and different functions. For example the tropical skin products 15 may be used for cleansing, moisturizing, protection from solar UV exposure, anti-aging, cooling, soothing, restoration of the skin barrier, pigmentation modulation, rejuvenation, reducing pigmentation, exfoliation, firming, and or other functions.

In some embodiments, system 10 may include one or more sensors 14 configured to generate output signals conveying information related to the skin characteristics of the user. Information related to the skin characteristics of the user include skin type, skin condition, skin hydration level, skin color, elasticity, epidermal thickness, dermal thickness, surface sebum content, pore density and/or dimensions, hair density, perfusion, and/or other information related to skin of the user. In some embodiments, sensors 14 may be and/or include one or more of a camera, a corneometry sensor (measurement of hydration of the outer layer of the epidermis), an optical sensor, a color sensor, a dermoscopy camera, a microscope, an optical coherence tomography system, a blood pressure monitor, a weight scale, and/or other sensors. In some embodiments, sensors 14 may be disposed in a plurality of locations within or outside of system 10. For example, sensors 14 may be located within the personal care device 16, coupled with the user interface, and/or in other locations within or outside of system 10. In some embodiments, sensors 14 may be part of other skin measurement devices (e.g., external resources 44) that are configured to be in wired and/or wireless communication with the personal care device and/or processors 18 regarding the skin condition of the user. Such devices may be used in a professional or retail setting at a lower frequency than device usage.

In some embodiments, sensors 14 may be configured to transmit (e.g., wired or wirelessly) information directly to processors 18. In some embodiments, information may be transmitted to processors 18 from a remotely located database that is part of external resources 44, for example. In some embodiments, processors 18 may obtain information from a database, sensors 14, and/or other resources by electronically querying and/or requesting information from such devices and receiving the information in response. It should be noted that these examples are not intended to be limiting. Processors 18 may be configured to receive and/or obtain information identifying the personal care device, information from the sensors, and/or any other information in any way that allows system 10 to function as described herein.

Processor 18 is configured to provide information processing capabilities in system 10. As such, processor 18 may comprise one or more of a digital processor, an analog processor, a digital circuit designed to process information, an analog circuit designed to process information, a state machine, and/or other mechanisms for electronically processing information. In some embodiments, processor 18 may comprise a plurality of processing units. These processing units may be physically located within the same device (e.g., a server), or processor 18 may represent processing functionality of a plurality of devices operating in coordination (e.g., a server; computing devices associated with a user, user interface 42, personal care device 16, devices that are part of external resources 44, and/or other devices.)

As shown in FIG. 1, processor 18 is configured via machine-readable instructions to execute one or more computer program components. The one or more computer program components may comprise one or more of a personal care device component 20, an access component 22, an extraction component 24, a recommendation component 26, a communications component 28 and/or other components. Processor 18 may be configured to execute components 20, 22, 24, 26 and/or 28 by software; hardware; firmware; some combination of software, hardware, and/or firmware; and/or other mechanisms for configuring processing capabilities on processor 18.

It should be appreciated that although components 20, 22, 24, 26 and 28 are illustrated in FIG. 1 as being co-located within a single processing unit, in embodiments in which processor 18 comprises multiple processing units, one or more of components 20, 22, 24, 26 and/or 28 may be located remotely from the other components. The description of the functionality provided by the different components 20, 22, 24, 26 and/or 28 described below is for illustrative purposes, and is not intended to be limiting, as any of components 20, 22, 24, 26 and/or 28 may provide more or less functionality than is described. For example, one or more of components 20, 22, 24, 26 and/or 28 may be eliminated, and some or all of its functionality may be provided by other components 20, 22, 24, 26 and/or 28. As another example, processor 18 may be configured to execute one or more additional components that may perform some or all of the functionality attributed below to one of components 20, 22, 24, 26 and/or 28.

Personal care device component 20 is configured to obtain information that identifies personal care device 16. In some embodiment, personal care device component 20 is configured to receive information that identifies the personal care device via an input from the user, and/or input from other components within or outside system 10. For example, the user may provide, via user interface 42, a name, model, a serial number, a picture of the personal care device, a bar code, and/or other identifiers of the personal care device. in some embodiments, user interface 42 may include a scanner configured to scan the personal care device and such that component 20 may identify the personal care device from information extracted from the scan (e.g., picture of the personal care device, bar code, name, model, etc.) In some embodiments, user interface 42 is configured to present the user with different personal care devices, such that the user can enter and/or select the personal care device he/she wants. In some embodiments, the information that identifies the personal care device may be obtained through a combination of user input, user selection, scan, and/or other methods to obtain the identity of the personal care device. In some embodiments, the user may provide other information. For example, the user may provide input related to skin type (e.g., oily, dry, etc.), and/or other information.

In some embodiments, the input may include information other than the identity of personal care device 16. For example, such information includes information about accessories for personal care device 16, attachments to the device (type of brush head, type of exfoliating head, type of shaving head, etc.), settings of the device (e.g. the rotational speed of the device, treatment length, energy level), and/or other information. In some embodiments, personal care device component 20 may be configured to receive information that identifies the personal care device from the user input, and obtain additional information about the personal care device (e.g., accessories, attachments to the device, settings of the device, etc.) from other components within or outside system 10 (e.g., storage 40, database 30, external resources 44, etc.).

Access component 22 is configured to access one or more databases (e.g., reviews database 30) storing one or more reviews associated with the personal care device. In some embodiments, access component 22 may access the one or more databases via a network 50 (described herewith) and/or other methods. Access component 22 may be configured to receive requests for information and/or data, provide the requested information and/or data, provide locations where the requested information and/or data can be accessed, and/or facilitate access to information related to the personal care device, the user, and/or the topical skin product in other ways. Access component 22 may be configured to access the one or more databases in response to requests/query from the user, from components within or outside system 10, and/or other requests for access.

A review associated with the personal care device refers to a review provided by a user and/or consumer for the personal care device that describes her experience as a user of the personal care device and/or other information related to personal care device 16. A review of the personal care device may help in the shopping decision of a prospective buyer of the personal care device, and/or the topical skin products. A review may provide another user of the personal care device with information about better using the personal care device. In some embodiments, a review of the personal care device may include comments about performance, reliability, quality, price, comparison with competing products and/or other information. In some embodiments, a review associated with the personal care device includes comments about the performance of the personal care device when used with different products, with different settings, with different accessories, and/or with different skin types.

Sources for user reviews (reviews database 30) may include e-commerce sites (e.g., Amazon, Zappos, etc.), social media sites (e.g., Facebook, Instagram, Twitter, etc.), blogs, online review websites, web pages, emails, documents, PDFs, scanned text, and/or other sources containing reviews related to the personal care device. In some embodiments, reviews associated with the personal care device may include ratings of the personal care device (e.g., star ratings, thumps up or down, etc.). in some embodiments, the reviews are in the form of text, audio, and/or video. In some embodiments, reviews associated with the personal care device include reviews by professionals, researchers, experts, and/or other users of the personal care device. In some embodiments, access component 22 is configured to access, one or more databases (e.g., reviews database 30) storing one or more reviews associated with one or more topical skin products 15. In some embodiments, the review may be for a topical skin product and also include comments and/or information about the topical skin product when used with personal care device 16.

Extraction component 24 is configured to extract, from the reviews associated with the personal care device and/or the topical skin products, information indicating the fitness level of the one or more topical skin products 15 with the personal care device 16. A fitness level refers to the level a given topical skin product fits and/or is compatible with the personal care device 16. For example, topical skin products with a high fitness level are products that yield the best results when used with the personal care device. A topical skin product with a low fitness level is a product that might be used with the personal care device but the results are relatively less desirable than skin treatment results for topical skin products with a high level fitness. In some embodiments, topical skin products 15 may be ranked based on the reviews. For example, products with the highest number of positive reviews (about usage with the personal care device) may have a high level of fitness with the personal care device. Products with the lowest number of positive reviews (about usage with the personal care device) may have a low level of fitness with the personal care device. Automatic extraction of information indicating the fitness level of the one or more topical skin products 15 with the personal care device 16 may be done using techniques such as HTTP programming, HTML parsing, DOM (document object model) parsing, machine learning techniques, text pattern matching, text analytics and/or other technique.

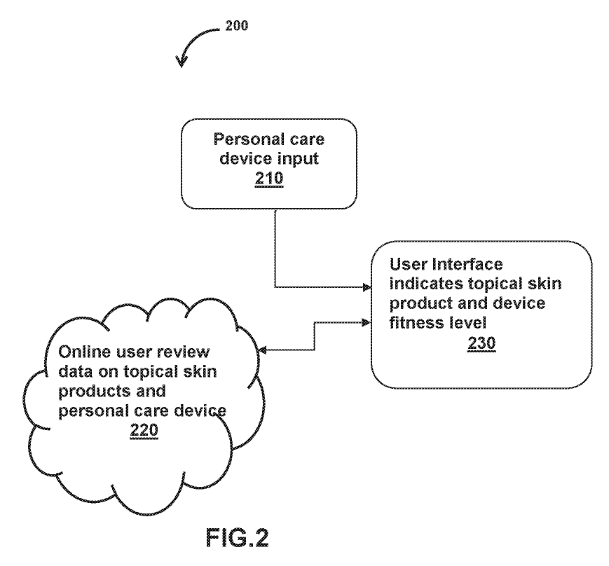

Recommendation component 26 is configured to analyze the extracted information, information from sensors 14, information about the user, and/or other information, and generate one or more recommendations indicating the fitness level of one or more topical skin products with the personal care device based on the analysis of the information extracted from the reviews, the sensor information, information about the user, and/or other information. In some embodiments, recommendation component 26 may generate a relative ranking of recommended topical skin products based on their levels of fitness with the personal care device. Analysis of the extracted information may include comparison of the content of the reviews with the user's information, and/or the sensors information. In some embodiments, recommendation component 26 may recommend one or more topical skin products that satisfy different factors. For example, recommend only skin products for which the ratings, from users with the same skin type, are above 4 stars. FIG. 2 is an example diagram 200 showing a user interface indicating a topical skin product and personal care device fitness level 230 based on personal care device input 210, and online review data on topical skin product and personal care device 220. As shown in FIG. 2, information identifying the personal care device is received. As described above, this information may be obtained from a user input or from a sensor's reading for example. Extraction component 24 (described above) is configured to extract online user review data on the personal care device and different topical skin products 220. Recommendation component 26 (described above) is configured to generate recommendations indicating a topical skin product and personal care device fitness level 230.

In some embodiments, extraction component 24 may be configured to collect information on the user (e.g., behaviors, activities, preferences, location, sensor 14 outputs, etc.). Recommendation component 26 may be configured to analyze the information extracted from the reviews along with the collected information on the user to predict user preferences based on his/her similarity to other users, and to generate one or more recommendations indicating the fitness a level of the one or more topical skin products with the personal care device based on the predicted user preferences. For example, if the user is about to buy a cleanser device and wants to know the best cleanser to use with the cleanser device, the user may provide information identifying the cleanser device via a user interface (e.g., an app on the user's mobile phone). The user may be asked to enter additional information (e.g., type of skin, fragrance preference, hygiene routine, goal of using the cleanser device, favorite brands or manufacturers, etc.). The user may be asked to rate, and or rank a product or sets of products. The user may be asked to take a picture of his skin. The user may be asked for permission for access to the user profile on different social media sites (instead of asking the user questions, extraction component will be able to extract information about the user's behavior, past purchases, activities, preferences, user's ratings of other products, likes and dislikes, etc.). This operation may be performed by personal care device component 20, and/or other components within or outside of system 10. Extraction component 24 may be configured to collect and store data about the user (e.g., products viewed, and/or bought online, viewing times, rating, behavior, etc.) extracted from information provided by the user or extracted from the users' profile on a social media site or an online store for example. In this example, recommendation component 26 generates recommendations based on the user's information by comparing information in reviews from users with similar profiles as the user (e.g., users with a rating history similar to that of the user, user in the same demographic profile of the user, same skin brand preferences, skin type, etc.) and making topical skin product recommendations similar to those liked by the users with the same demographic profile.

In some embodiments, recommendation component 26 may use information related to the user's past purchases to recommend one or more topical skin products. This information may be extracted from the user input, and/or from the users' profile on a social media site or online store for example. For example, recommendation components 26 may be configured to recommend topical skin products that are similar to those the user liked or bought in the past. In some cases, recommendation component 26 may rank or assign a score to possible topical skin products by comparing them with products previously rated or bought by the user. Machine learning techniques such as Bayesian Classifiers, kNN classifiers, cluster analysis, decision trees, and artificial neural networks may be used to estimate the probability that the user will like the recommendation.

In some embodiments, recommendation component 26 may be configured to generate recommendations based on the location of the user. Recommendation component 26 may use location information from a locator (e.g., GPS) to recommend topical skin products that are within a given range of the user. In some embodiments, the locator may be included in sensors 14, personal care device 16, and/or other components within or outside system 10. For example, if the user is in a Target store, recommendation component may recommend topical skin products based on a combination of users' reviews, the user information, the topical skin products that are available for sale at the Target store, and/or other information.

In some embodiments, recommendation component 26 may be configured to generate recommendations indicating the fitness level of the one or more topical skin products when used before use of the personal care device, when used concurrently with the personal care device, and/or when used after use of the personal care device. For example, recommendation component 26 may generate a recommendation of a set of topical skin products to be used with the personal care device based on users' reviews, the user and or other extracted information. the set of topical skin products may include topical skin products to be used before use of the personal care device (to prepare the skin for example), topical skin products to be used concurrently with the personal care device, and topical skin products to be used after the personal care device (lotion for example). The topical skin products in the recommendation may be from the same brand of from different brands.

In some embodiments, recommendation component 26 may recommend a regimen to the user based on reviews of the personal care device, reviews of topical skin products, on information related to the user (e.g., skin type, color, texture, etc.), and/or other factors. For example, a recommendation may direct the user the specific topical skin product for a given period of time and switch to a different topical skin product after wards. In some embodiments, where recommendation component 26 is located in the personal care device, recommendation component 26 may be configured to detect changes in the skin of the user and update the recommendations based on the changes of in the skin. For example, recommendations may include stop usage of the topical skin product, change the topical skin product, frequency of usage, add another topical skin product, upgrade the personal care device, use different settings or attachments, etc. For example, the user may be using an electrical toothbrush with a first toothpaste (the user received a first recommendation from the system to use the first tooth paste when he bought the toothbrush for example). The user may receive a second recommendation to change the toothpaste after few weeks of use responsive to the toothbrush detecting a change in the teeth or gum of the user (for example, gum sensitivity, or teeth achieving a level of whitening desired, etc.). In this example, sensors 14 are included in the toothbrush and processors 18 may be located in the toothbrush or in another location.

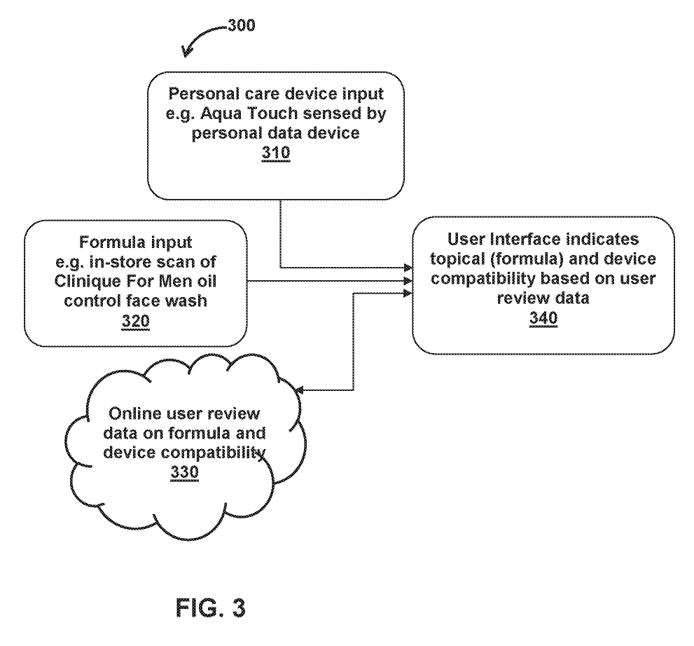

In some embodiments, recommendation component 26 may be configured to provide one or more recommendations on the fitness level of a specific topical skin product with the personal care device. The user may input information identifying a specific topical skin product (for example via user interface 42) inquiring whether he should use it with the personal care device. Recommendation component 26 may generate a recommendation based on reviews of other users who used the specific topical skin product with the personal care device, user information, and/or other factors (e.g., factors discussed above). FIG. 3 is an example diagram 300 showing a user interface indicating a topical skin product and device fitness level 340 determined as described above based on personal care device input 310, specific topical skin product 320, and online review data on the specific topical skin product and the personal care device 330. As shown in FIG. 3, information identifying the personal care device and a specific topical skin product is received. As described above, this information may be obtained from a user input or from a sensor's reading for example. Extraction component 24 (described above) is configured to extract online user review data on the personal care device and the specific topical skin product 330. Recommendation component 26 (described above) is configured to generate recommendations indicating the specific topical skin product and personal care device fitness level 340.

Returning to FIG. 1, in some embodiments, recommendation component 26 may be configured to generate recommendations based on a skin treatment cosmetic goal for the user. For example, personal care device component 20 may be configured to obtain information related to a skin treatment cosmetic goal for the user. For example, through questions that guides the user in describing his/her skin treatment cosmetic goal, or by presenting the user with different goals to choose from. Extraction component 24 may be configured to extract information from reviews of other users who accomplished similar skin treatment cosmetic goals. Example of treatment goals may include smoother skin, fairer skin, fewer blemishes, less redness, less visible pores. Recommendation component 26 may generate recommendation on the skin treatment cosmetic goal, reviews of other users who accomplished similar skin treatment cosmetic goals, degree of success of the other users, information related to the user (type of skin, hygiene habits, etc.), and/or other factors.

In some embodiments, recommendation component 26 may be configured to generate recommendations indicating the fitness level of the one or more topical skin products with the different settings and/or attachments of the personal care device. The recommendations may indicate one or more settings, and/or one or more attachment to be used with one or more topical skin products. For example, recommendation component 26 may recommend use of a gentle topical skin product with an aggressive setting of the personal care device (e.g., exfoliating), or a more aggressive topical skin product with a gentle setting of the personal care device, and/or other combinations depending on the setting of the device, the attachments used with the device and the goal of treatment.

Communication component 28 is configured to communicate the recommendations to the user. Communication component 28 is configured to communicate via user interface 42, via email, via text messages, via a website, via a phone call, and or with other forms of communication. For example, in some embodiments, communication component 28 causes user interface 42 to display information that communicates the recommendations, the extracted reviews, and/or other information. In some embodiments, communication component 28 is configured to send an email or a text with such information to the user.

Electronic storage 40 comprises electronic storage media that electronically stores information. The electronic storage media of electronic storage 40 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 40 may be (in whole or in part) a separate component within system 10, or electronic storage 40 may be provided (in whole or in part) integrally with one or more other components of system 10 (e.g., user interface 42, processor 18, etc.). In some embodiments, electronic storage may be located in a server together with processor 18, in a server that is part of external resources 44, in a computing device associated with the user and/or other users, and/or in other locations. Electronic storage 40 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 40 may store software algorithms, information determined by processor 18, information received via user interface 42 and/or external computing systems, information received from external resources 44, information received from sensors 14, and/or other information that enables system 10 to function as described herein.

User interface 42 is configured to receive information from and/or provide information to one or more users of system 10. User interface may be located in personal care device 16, a personal computing device, and/or other locations within or outside system 10. User interface 42 is configured to provide an interface between system 10 and the user. This enables data, images, cues, results, and/or instructions and any other communicable items, collectively referred to as “information,” to be communicated between the user, processor 18, personal care device 16, and/or other components of system 10. For example, recommendations, reviews, graphs, predictions, and/or other information may be communicated from system 10 to the user via user interface 42. In some embodiments, user interface 42 may provide direct links to retail websites for the consumer to purchase a topical product, device attachment or other component.

Examples of interface devices suitable for inclusion in user interface 42 comprise a graphical user interface, a display, a touchscreen, a keypad, buttons, switches, a keyboard, knobs, levers, speakers, a microphone, an indicator light, an audible alarm, a printer, a haptic feedback device, an optical scanner, a bar-code reader, a camera, and/or other interface devices. In some embodiments, user interface 42 comprises a plurality of separate interfaces. For example, user interface 42 may comprise a plurality of different interfaces associated with a plurality of computing devices associated with different caregivers; an interface that is part of a computing device associated with the user; an interface associated with personal care device 16, processor 18, electronic storage 40, external resources 44, sensors 14, and/or other components of system 10; an interface included in a server that also includes processor 18 and/or electronic storage 40; and/or other interfaces. User interface 42 is configured such that a user may provide information to and receive information from system 10 via the individual ones of the plurality of user interfaces. In some embodiments, user interface 42 comprises at least one interface that is provided integrally with processor 18 and/or other components of system 10.

It is to be understood that other communication techniques, either hard-wired or wireless, are also contemplated by the present disclosure as user interface 42. For example, the present disclosure contemplates that user interface 42 may be integrated with a removable storage interface provided by electronic storage 40. In this example, information may be loaded into system 10 from removable storage (e.g., a smart card, a flash drive, a removable disk, etc.) that enables the user(s) to customize the implementation of system 10. Other exemplary input devices and techniques adapted for use with system 10 as user interface 42 comprise, but are not limited to, an RS-232 port, RF link, an IR link, modem (telephone, cable or other). In short, any technique for communicating information with system 10 is contemplated by the present disclosure as user interface 42.

External resources 44 may include sources of information (e.g., databases, websites, etc.), external entities participating with system 10 (e.g., a medical records system of a health care provider), medical equipment configured to communicate with external systems, one or more servers outside of system 10, a network (e.g., the internet), electronic storage, equipment related to Wi-Fi technology, equipment related to Bluetooth® technology, data entry devices, sensors, scanners, computing devices associated with individual users, and/or other resources. In some implementations, some or all of the functionality attributed herein to external resources 44 may be provided by resources included in system 10. External resources 44 may be configured to communicate with sensors 14, processor 18, electronic storage 40, user interface 42, and/or other components of system 10 via wired and/or wireless connections, via a network (e.g., a local area network and/or the internet), via cellular technology, via Wi-Fi technology, and/or via other resources.

Network 50 may include the Internet and/or other networks, Intranets, a PAN (Personal Area Network), a LAN (Local Area Network), a WAN (Wide Area Network), a SAN (Storage Area Network), a MAN (Metropolitan Area Network), near field communication, frequency (RF) link, Bluetooth, Wi-Fi, Li-FI, a cellular communications network, a Public Switched Telephone Network, and/or any type(s) of wired or wireless network(s). It will be appreciated that this is not intended to be limiting and that the scope of this disclosure includes embodiments in which the components of system 10 are operatively linked via some other communication media. In some cases, the network is a secure local area network, such as a wired Ethernet network behind a firewall.

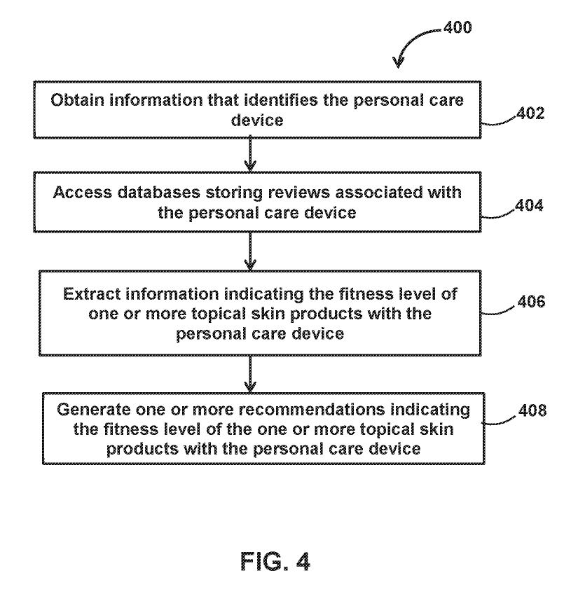

FIG. 4 illustrates a method 400 for providing a user with recommendations indicating a fitness level of one or more topical skin products with a personal care device. The system comprises one or more one or more sensors, one or more user interfaces, electronic storage, external resources, one or more hardware processors, and/or other components. The one or more hardware processors are configured to execute computer program components. The computer program components comprise a sensor information component, a parameter component, a prediction component, a communication component, and/or other components. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, information that identifies the personal care device is obtained. In some embodiments, operation 402 is performed by a processor component the same as or similar to sensor information component 20 (shown in FIG. 1 and described herein).

At an operation 404, one or more databases storing one or more reviews associated with the personal care device are accessed. The one or more databases may be obtained via a network. The reviews may include information about user experience with the personal care device and the one or more topical skin products. In some embodiments, operation 204 is performed by a processor component the same as or similar to parameter component 22 (shown in FIG. 1 and described herein).

At an operation 406, information indicating the fitness level of the one or more topical skin products with the personal care device is extracted from the reviews associated with the personal care device. In some embodiments, operation 406 is performed by a processor component the same as or similar to prediction component 24 (shown in FIG. 1 and described herein).

At an operation 408, one or more recommendations indicating the fitness level of the one or more topical skin products with the personal care device is generated based on analysis of the extracted reviews. In some embodiments, operation 408 is performed by a processor component the same as or similar to prediction component 26 (shown in FIG. 1 and described herein).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A system configured to provide a user with recommendations indicating a fitness level of one or more topical skin products with a personal care device, the system comprising:
one or more hardware processors configured by machine-readable instructions to:
obtain information that identifies the personal care device;
access, via a network, one or more databases storing one or more reviews associated with the personal care device, wherein the reviews include information about user experience with the personal care device and the one or more topical skin products;
extract, from the reviews associated with the personal care device, information indicating the fitness level of the one or more topical skin products with the personal care device; and
generate one or more recommendations indicating the fitness level of the one or more topical skin products with the personal care device based on analysis of the extracted reviews.

2. The system of claim 1, wherein the one or more hardware processors are further configured to cause display of the extracted reviews and/or the one or more recommendations on the personal care device and/or a computing device.

3. The system of claim 1, wherein the one or more hardware processors are further configured to obtain information identifying a specific topical skin product and to provide one or more recommendations on the fitness level of the specific topical skin product with the personal care device.

4. The system of claim 1, wherein the one or more hardware processors are further configured to obtain information related to a user skin treatment cosmetic goal and wherein the one or more recommendations are further based on the user skin treatment cosmetic goal.

5. The system of claim 1, wherein the one or more hardware processors are further configured to generate recommendations indicating the fitness level of the one or more topical skin products when used before use of the personal care device, when used concurrently with the personal care device, and/or when used after use of the personal care device.

6. The system of claim 1, wherein the one or more hardware processors are further configured to generate recommendations indicating the fitness level of the one or more topical skin products with the personal care device based on settings of the personal care device, and/or attachments used with the personal care device.

7. A method for providing a user with recommendations indicating a fitness level of one or more topical skin products with a personal care device, with a recommendation system, the system comprising one or more hardware processors, the method comprising:
obtaining, with the one or more hardware processors, information that identifies the personal care device;
accessing, with the one or more hardware processors, via a network, one or more databases storing one or more reviews associated with the personal care device, wherein the reviews include information about user experience with the personal care device and the one or more topical skin products;
extracting, with the one or more hardware processors, from the reviews associated with the personal care device, information indicating the fitness level of the one or more topical skin products with the personal care device; and
generating, with the one or more hardware processors, one or more recommendations indicating the fitness level of the one or more topical skin products with the personal care device based on analysis of the extracted reviews.

8. The method of claim 7, further comprising causing, with the one or more hardware processors, display of the extracted reviews and/or the one or more recommendations on the personal care device and/or a computing device.

9. The method of claim 7, further comprising obtaining, with the one or more hardware processors, information identifying a specific topical skin product and to provide one or more recommendations on the fitness level of the specific topical skin product with the personal care device .

10. The method of claim 7, further comprising obtaining, with the one or more hardware processors, information related to a user skin treatment cosmetic goal and wherein the one or more recommendations are further based on the user skin treatment cosmetic goal.

11. The method of claim 7, wherein generating the one or more recommendations indicating the fitness level of the one or more topical skin products with the personal care device include recommendations indicating the fitness level of the one or more topical skin products when used before use of the personal care device, when used concurrently with the personal care device, and/or when used after use of the personal care device.

12. The method of claim 7, wherein generating the one or more recommendations indicating the fitness level of the one or more topical skin products with the personal care device is based on settings of the personal care device, and/or attachments used with the personal care device.

13. A system configured to provide a user with recommendations indicating a fitness level of one or more topical skin products with a personal care device, the system comprising:
means for obtaining information that identifies the personal care device;
means for accessing, via a network, one or more databases storing one or more reviews associated with the personal care device, wherein the reviews include information about user experience with the personal care device and the one or more topical skin products;
means for extracting from the reviews associated with the personal care device, information indicating the fitness level of the one or more topical skin products with the personal care device; and
means for generating one or more recommendations indicating the fitness level of the one or more topical skin products with the personal care device based on analysis of the extracted reviews.

14. The system of claim 13, further comprising means for causing display of the extracted reviews and/or the one or more recommendations on the personal care device and/or a computing device.

15. The system of claim 13, further comprising means for obtaining information identifying a specific topical skin product and to provide one or more recommendations on the fitness level of the specific topical skin product with the personal care device.

16. (canceled)

17. (canceled)

18. (canceled)
